(19) United States
(12) Patent Application Publication
(10) Pub. No.: US 2026/0252975 A1
(43) Pub. Date: Aug. 27, 2026

(54) CANCELLATION ESTIMATION USING LOCATION INFORMATION

(71) Applicant: Rakuten Group, Inc., Tokyo (JP)

(72) Inventors: Saki TANAKA, Tokyo (JP); Haruka HORIUCHI, Tokyo (JP); Keisuke TAKAMI, Tokyo (JP)

(73) Assignee: Rakuten Group, Inc., Tokyo (JP)

(21) Appl. No.: 18/861,722

(22) PCT Filed: Dec. 27, 2022
(86) PCT No.: PCT/JP2022/048345

§ 371 Date: Oct. 30, 2024

(51) Int. Cl. G06Q 10/02; H04W 4/02

(52) U.S. Cl. CPC G06Q 10/02; H04W 4/02

(57) ABSTRACT

Provided is a ticket management apparatus including one or more processors, and the one or more processors execute a process including: acquiring a current location of a wireless communication terminal held by a user that has purchased a ticket to participate in an event; acquiring a required time that is required to move from the current location of the wireless communication terminal to a venue of the event; estimating, by comparing the required time and a grace period from a current time to a start time of the event, a possibility that the user will cancel participation in the event; and when the estimated cancellation possibility satisfies a prescribed condition, transmitting a message to the wireless communication terminal to confirm whether or not there will be a cancellation.

### TECHNICAL FIELD

The present disclosure relates to cancellation estimation using location information.

### BACKGROUND

In general, participants in events such as concerts and sports matches, etc., purchase tickets from an event organizer in advance and present the tickets on the day of the event to enter a venue. In recent years, tickets are issued as electronic tickets and ticket information is stored on a terminal device such as a smartphone that a user carries, etc.

### CITATION LIST

### Patent Literature

Patent Document 1: Japanese Unexamined Patent Application, First Publication No. 2020-194504

### SUMMARY OF INVENTION

### Technical Problem

However, there is a problem of facilities at an event venue going unused when a participant in an event becomes unable to participate in the event due to unforeseen circumstances. In particular, when a participant that has purchased a ticket does not give prior notice when not going to an event venue, facilities such as a seat for that participant, etc., are not utilized effectively and the organizer of the event also suffers a detriment.

The present disclosure was devised in the light of the foregoing and has an objective of providing cancellation estimation which uses location information and which can achieve effective utilization of the facilities of an event venue.

### Solution to Problem

According to one embodiment of the present disclosure, a ticket management apparatus has one or more processors. The one or more processors execute a process including: acquiring a current location of a wireless communication terminal held by a user that has purchased a ticket to participate in an event; acquiring a required time that is required to move from the current location of the wireless communication terminal to a venue of the event; estimating, by comparing the required time and a grace period from a current time to a start time of the event, a possibility that the user will cancel participation in the event; and when the estimated cancellation possibility satisfies a prescribed condition, transmitting a message to the wireless communication terminal to confirm whether or not there will be a cancellation.

Further, according to one embodiment of the present disclosure, a cancellation estimation method includes: acquiring a current location of a wireless communication terminal held by a user that has purchased a ticket to participate in an event; acquiring a required time period that is required to move from the current location of the wireless communication terminal to a venue of the event; estimating, by comparing the required time and a grace period from a current time to a start time of the event, a possibility that the user will cancel participation in the event; and when the estimated cancellation possibility satisfies a prescribed condition, transmitting a message to the wireless communication terminal to confirm whether or not there will be a cancellation.

### BRIEF DESCRIPTION OF DRAWINGS

FIG. 1 illustrates an example of a cancellation estimation system according to one embodiment.

FIG. 2 is a block diagram illustrating a configuration of a ticket management apparatus according to one embodiment.

FIG. 3 is a flow diagram illustrating operations of a ticket management apparatus according to one embodiment.

FIG. 4 is a flow diagram illustrating a required time calculation method.

FIG. 5 is a sequence diagram illustrating a cancellation estimation method.

FIG. 6 is a block diagram illustrating an example of a hardware configuration of a ticket management apparatus.

### DESCRIPTION OF EMBODIMENTS

Below, one embodiment according to the present disclosure will be described with reference to the attached drawings. The embodiment described below is exemplary and the present disclosure is not to be construed as being limited by this description.

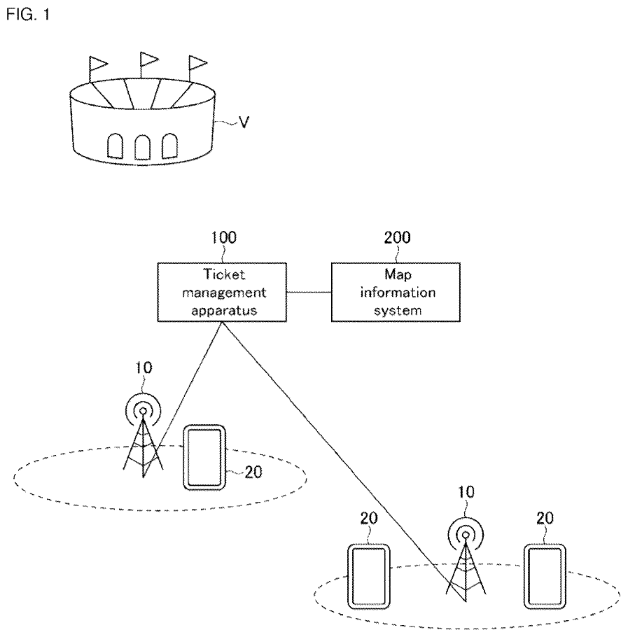

FIG. 1 illustrates an example of a cancellation estimation system according to one embodiment. The cancellation estimation system shown in FIG. 1 estimates a possibility that a participant will cancel participation in an event in which the participant holding a ticket for can participate when the event is held at an event venue V. This cancellation estimation system has a ticket management apparatus 100 and a map information system 200, and the ticket management apparatus 100 connects to a mobile network which includes base stations 10 and user terminals 20.

The base stations 10 form cells in a range reachable by radio waves and execute wireless communication with the user terminals 20 within the cells. The cells formed by the base stations 10 are each provided with a cell ID which is identification information, and from the cell ID, it is possible to identify a base station 10 forming a respective cell.

When located within a cell formed by a base station 10, the user terminals 20 execute wireless communication with the base station 10 forming that cell. Among these user terminals 20, the user terminal 20 of a participant that is to participate in an event held at the event venue V stores ticket information of a ticket needed to participate in the event. Accordingly, an event participant can, for example, enter the event venue V and participate in the event by presenting the ticket information stored in the user terminal 20.

The ticket management apparatus 100 manages ticket information that user terminals 20 store. When storing ticket information, the ticket management apparatus 100 associates ticket information of a ticket issued to a user terminal 20 of a participant that has purchased a ticket with identification information of the user terminal 20. In addition, the ticket management apparatus 100 estimates a possibility that participation in an event will be canceled on the basis of a current location of each user terminal 20 before the start of the event. The ticket management apparatus 100 confirms whether or not there will be a cancellation with user terminals 20 having a high possibility for canceling participation in an event and when a cancellation is confirmed, reflects a cancellation occurrence in the ticket information. Note that the configuration and operations of the ticket management apparatus 100 will be described in detail later.

The map information system 200 is a system which is capable of storing map information as well as collecting dynamic information such as weather and traffic information, etc., processing map information, and searching for composite information. Examples of such a map information system 200 include a dynamic map system. The map information system 200 receives a request from the ticket management apparatus 100 and calculates a required time that is required to move from the current location of a user terminal 20 to the event venue V. At that time, the map information system 200 searches for a shortest route from the current location of the user terminal 20 to the event venue V and calculates the required time by taking into consideration weather and traffic information for the shortest route.

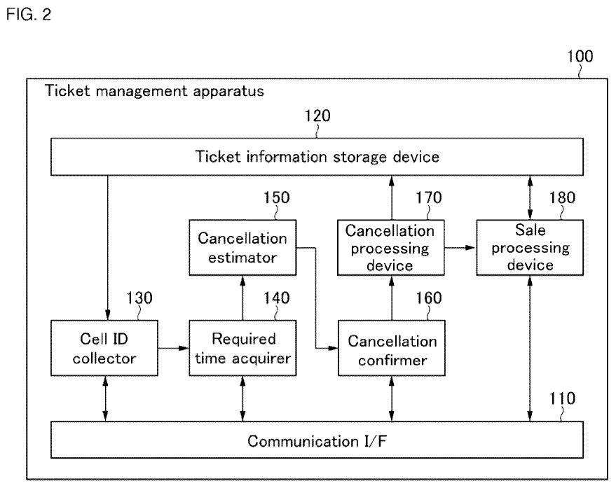

FIG. 2 is a block diagram illustrating a configuration of the ticket management apparatus 100 according to one embodiment. The ticket management apparatus 100 shown in FIG. 2 has a communication interface (hereinafter abbreviated to “communication I/F”) 110, a ticket information storage device 120, a cell ID collector 130, a required time acquirer 140, a cancellation estimator 150, a cancellation confirmer 160, a cancellation processing device 170, and a sale processing device 180.

The communication I/F 110 has an interface for communicating with the base stations 10, the user terminals 20, and the map information system 200, and transmits and receives various kinds of information. Specifically, the communication I/F 110 receives, from a user terminal 20, a cell ID of a cell within which the user terminal 20 is located, and transmits, to the map information system 200, a calculation request to request calculation of a required time.

When storing ticket information, the ticket information storage device 120 associates ticket information of a ticket issued to a user terminal 20 with the identification information of the user terminal 20. That is, when a user purchases a ticket to participate in an event, the ticket information storage device 120 stores the ticket information by associating, with the identification information of the user terminal 20 of that user, ticket information including information such as the date and time that the event will be held, venue, and seat type, etc.

Before the start of the event, the cell ID collector 130 calculates a grace period from the current time to the event start time, and at a timing at which the grace period becomes a prescribed time, transmits a cell ID transmission request to the user terminals 20 that have ticket information. In addition, the cell ID collector 130 collects, from the user terminals 20, cell IDs which identify cells in which respective user terminals 20 are currently in communication. The cell ID collector 130 identifies locations of the base stations 10 corresponding to the cell IDs collected from the user terminals 20 and provides notification of the locations of the base stations 10 to the required time acquirer 140 as the current location of each user terminal 20.

When notification of the current locations of the user terminals 20 is provided from the cell ID collector 130, the required time acquirer 140 transmits, to the map information system 200, a calculation request to calculate required times from the current locations of the user terminals 20 to the event venue V. In addition, the required time acquirer 140 acquires, from the map information system 200, required times from the current locations of the user terminals 20 to the event venue V as a response corresponding to the calculation request.

The cancellation estimator 150 estimates a possibility that a user holding a user terminal 20 will cancel participation in the event on the basis of the required time to the event venue V for each user terminal 20. Specifically, the cancellation estimator 150 compares the grace period until the start of the event and a required time to the event venue V for the user terminals 20 and determines whether or not the required time is equal to or less than the grace period. In addition, when the required time is equal to or less than the grace period, since the arrival of a user at the event venue V will be in time for the start of the event, the cancellation estimator 150 estimates that there is a low possibility that that user will cancel. Further, when the required time exceeds the grace period, since the arrival of a user at the event venue V will not be in time for the start of the event, the cancellation estimator 150 estimates that there is a high possibility that that user will cancel.

The cancellation confirmer 160 transmits, to the user terminal 20 of a user that was estimated by the cancellation estimator 150 as having a high possibility of cancellation, a confirmation message to confirm whether or not participation in the event will be canceled. In addition, the cancellation confirmer 160 receives, from the user terminal 20, information indicating whether or not participation in the event will be canceled as a response corresponding to the confirmation message that was transmitted.

The cancellation processing device 170 executes a cancellation process for a user for which it was confirmed by the cancellation confirmer 160 that participation in the event will be canceled. Specifically, the cancellation processing device 170 updates the ticket information that is stored in the ticket information storage device 120 and associated with the user terminal 20 of a user that will cancel participation in the event, and registers the fact that participation has been canceled.

When a cancellation process is executed by the cancellation processing device 170, the sale processing device 180 executes a sale process on surplus tickets generated due to a cancellation. That is, the sale processing device 180, for example, performs a procedure to sell surplus tickets at a prescribed sales site, and makes an inquiry to a pre-registered user terminal 20 regarding whether or not a purchase of a surplus ticket is desired. In addition, when a surplus ticket is purchased, the sale processing device 180 updates the ticket information of the surplus ticket stored in the ticket information storage device 120 and associates the updated ticket information with the user terminal 20 of the user that purchased the ticket.

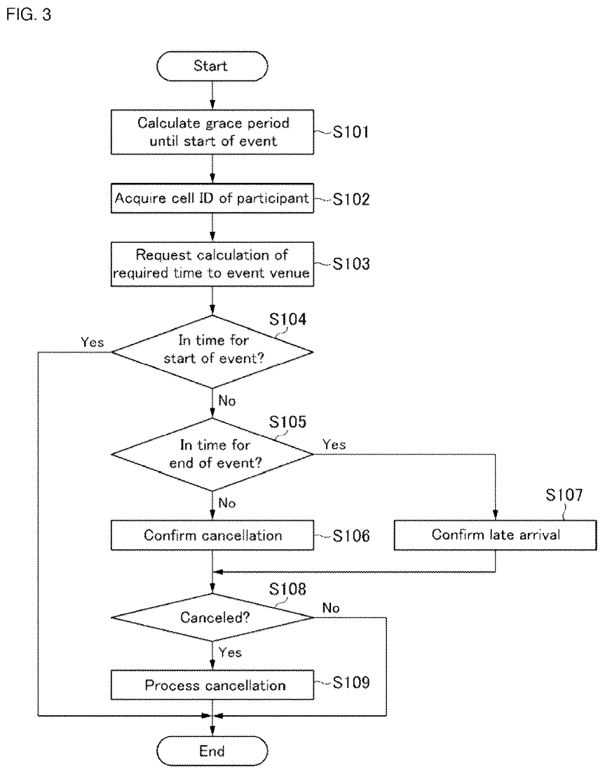

Next, a ticket management method by the ticket management apparatus 100 configured as described above shall be explained with reference to the flow diagram shown in FIG. 3.

Before the start of an event, ticket information is associated with identification information of user terminals 20 of participants that purchased tickets for the event and is stored in the ticket information storage device 120 of the ticket management apparatus 100. In addition, a grace period from a current time until the start of the event is calculated by the cell ID collector 130 (step S101) and, at a timing at which the grace period becomes a prescribed time, a cell ID transmission request is transmitted to terminal devices 20 of the participants that purchased tickets. In response to the transmission request, a user terminal 20 of a participant transmits a cell ID of a cell in which the user terminal 20 is currently located to the ticket management apparatus 100 via a base station 10. The cell IDs transmitted from each user terminal 20 are acquired by the cell ID collector 130 (step 102).

Since the cell ID is identification information unique to a base station 10, the base station 10 to which a respective user terminal 20 is currently connected is identified from the cell ID by the cell ID collector 130. In addition, the locations of the base stations 10 are identified and notice of the locations of the base stations 10 that are currently connected is provided to the required time acquirer 140 as the current location of each user terminal 20. Note that, instead of collecting a cell ID from each user terminal 20, the cell ID collector 130 may also collect, from each user terminal 20, location information of a current location that a user terminal 20 determines by using, for example, global positioning system (GPS).

When notification of the current locations of the user terminals 20 is provided, the required time acquirer 140 transmits, to the map information system 200, a calculation request to calculate a required time from the current locations of the user terminals 20 to the event venue V (step S103). The map information system 200 calculates required times required for each of the user terminals 20 to move to the event venue V and transmits information regarding the required time for each user terminal 20 to the ticket management apparatus 100. The calculation of the required time performed by the map information system 200 is described in detail later. The information regarding the required time that is transmitted from the map information system 200 is acquired by the required time acquirer 140.

In addition, the required time for each user terminal 20 is used by the cancellation estimator 150 to estimate a possibility that a user holding a respective user terminal 20 will cancel participation in the event. Specifically, the grace period until the start of the event and the required time to the event venue V are compared and a determination is made as to whether or not the arrival of a user at the event venue V will be in time for the start of the event (step S104). When the result of this determination is that the required time is equal to or less than the grace period and the arrival of a user at the event venue V will be in time for the start of the event (step S104 Yes), it is determined that there is a low possibility that the user will cancel participation in the event, and the process ends.

Meanwhile, when the result of the determination in step S104 is that the required time exceeds the grace period and the arrival of a user at the event venue V will not be in time for the start of the event (step S104 No), a determination is then made as to whether or not the arrival of the user at the event venue V will be in time for the end of the event (step S105). This determination can be realized, for example, by comparing the required time to the event venue V and a time obtained by adding an event duration to the grace period until the start of the event. Further, when, for example, an admission time to the event venue V after the start of an event is limited, a required time may be compared against a time obtained by adding the admission time to the grace period.

When the result of the determination in step S105 is that the required time is equal to or less than the time obtained by adding the event duration to the grace period and the arrival of the user at the event venue V will be in time for the end of the event (step S105 Yes), it is determined that there is a possibility that the user will arrive late and participate in the event. Meanwhile, when the required time exceeds the time obtained by adding the event duration to the grace period and the arrival of the user at the event venue V will not be in time for the end of the event (step S105 No), it is determined that there is a high possibility that the user will cancel participation in the event.

When it is determined that there is a high possibility that the user will cancel participation in the event, the cancellation confirmer 160 transmits, to the user terminal 20, a confirmation message inquiring as to whether or not participation in the event will be canceled (step S106). Further, when it is determined that there is a possibility that the user will arrive late and participate in the event, the cancellation confirmer 160 provides notification that there is a possibility of not being in time for the start of an event, and also transmits, to the user terminal 20, a confirmation message inquiring as to whether or not participation in the event will be canceled (step S107).

The user terminal 20 that receives the confirmation message presents the confirmation message to the user and transmits, to the ticket management apparatus 100, a reply as to whether or not there will be a cancellation by the user. The reply as to whether or not there will be a cancellation which is transmitted from the user terminal 20 is acquired by the cancellation confirmer 160. In addition, the cancellation processing device 170 determines whether or not a reply indicating that participation in the event will be canceled has been obtained (step S108). When the result of this determination is that a reply indicating that participation in the event will not be canceled has been obtained (step S108 No), it is determined that the user will participate in the event and the process ends.

Meanwhile, when a reply indicating that participation in the event will be canceled has been received (step S108 Yes), a cancellation process is executed (step S109). That is, the ticket information stored in the ticket information storage device 120 is updated, and the fact that participation in the event has been canceled is registered for the user terminal 20 of the user that will cancel participation in the event. Due to the occurrence of such a cancellation, the canceled ticket becomes a surplus ticket. Thus, the sale processing device 180 executes a sale process to sell the surplus ticket. Due thereto, a canceled ticket can be purchased by another participant and that participant can participate in the event, and therefore, it is possible to achieve effective utilization of the facilities of the event venue V.

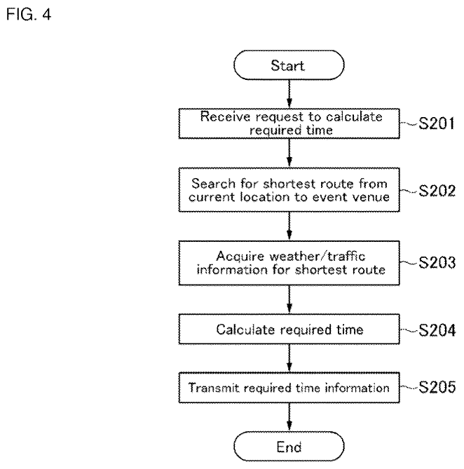

Next, the required time calculation method performed by the map information system 200 shall be explained with reference to the flow diagram shown in FIG. 4.

The map information system 200 receives, from the ticket management apparatus 100, a required time calculation request including information regarding a current location of a user terminal 20 and the location of the event venue V (step S201).

Upon receiving this request, the map information system 200 searches for the shortest route from the current location of the user terminal 20 to the event venue V (step S202). Here, the shortest route to be searched for is a route by which movement time from the current location of the user terminal 20 to the event venue V is the shortest time, and means of transportation for moving along this route may include various kinds.

When the shortest route is acquired by a search, the map information system 200 acquires information about weather and traffic information for the shortest route (step S203). In addition, from the movement time for moving along the shortest route, the map information system 200 calculates an actual required time in accordance with weather and traffic circumstances (step S204). The map information system 200 calculates a required time from a current location to the event venue V for each user terminal 20 and transmits, to the ticket management apparatus 100, required time information including the required time of each user terminal 20 (step S205).

Thus, since the required time is calculated in accordance with weather and traffic circumstances, notification of the required time required for a user terminal 20 to actually move to the event venue V is provided to the ticket management apparatus 100 and it is possible to accurately estimate the possibility of a cancellation.

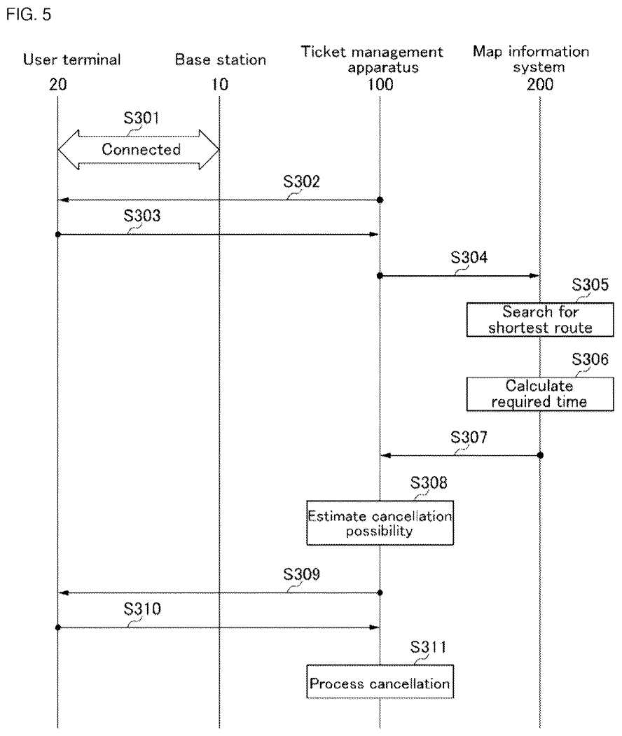

FIG. 5 is a sequence diagram illustrating a cancellation estimation method in the cancellation estimation system described above.

It is assumed that a user terminal 20 that has ticket information to participate in an event is currently connected to a base station 10 forming a cell in which the user terminal 20 is located (step 301). When the grace period until the start of an event becomes a prescribed time, the ticket management apparatus 100 transmits a cell ID transmission request to the user terminal 20 that has ticket information (step S302). In response to this transmission request, the user terminal 20 transmits, to the ticket management apparatus 100, a cell ID of the cell formed by the connected base station 10 (step S303).

When cell IDs are collected from each user terminal 20 that has ticket information, the ticket management apparatus 100 identifies the base stations 10 corresponding to the cell IDs. In addition, the ticket management apparatus 100 transmits, to the map information system 200, a calculation request to calculate a required time from current locations of the user terminals 20 to the event venue V with the locations of the base stations 10 serving as the current locations of the user terminals 20 (step S304). The map information system 200 searches for the shortest route from the current location of each user terminal 20 to the event venue V (step S305) and adds weather and traffic information in the shortest route to calculate the required time to the event venue V for each user terminal 20 (step S306). The map information system 200 transmits, to the ticket management apparatus 100, required time information including the required time of each user terminal 20 (step S307).

The ticket management apparatus 100 estimates a possibility that the users holding the user terminals 20 will cancel participation in the event on the basis of the required time for each user terminal 20 (step S308). That is, the ticket management apparatus 100 compares the grace period until the start of the event and the required time of a user terminal 20 to the event venue V, and when the required time is equal to or less than the grace period, since the arrival of a user at the event venue V will be in time for the start of the event, it is estimated that there is a low possibility that that user will cancel. Further, when the required time exceeds the grace period, since the arrival of the user at the event venue V will not be in time for the start of the event, the ticket management apparatus 100 estimates that there is a high possibility that that user will arrive late and participate in the event or cancel participation in the event.

The ticket management apparatus 100 transmits a confirmation message to confirm whether or not there will be a cancellation to the user terminal 20 of a user for which it is estimated there is a high possibility that participation will be with a late arrival or that participation in the event will be canceled (step S309). The user terminal 20 presents the confirmation message to the user and receives an input of a reply. In addition, the user terminal 20 transmits, to the ticket management apparatus 100, a reply as to whether or not there will be a cancellation (step S310). When a reply indicating that there will be a cancellation is obtained, the ticket management apparatus 100 executes a cancellation process to register the fact that there has been cancellation in the ticket information associated with that user terminal 20 (step S311).

Thus, the ticket management apparatus 100 estimates a possibility of a cancellation by a user on the basis of the required time from the current location of a user terminal 20 to the event venue V and inquires, of a user with a high possibility of cancellation, as to whether or not there will be a cancellation. Due thereto, it is possible to ascertain in advance that a user with a high possibility of cancellation will cancel participation in an event and to sell a surplus ticket generated due to the cancellation to another user. As a result thereof, another participant that purchases the surplus ticket can participate in the event, and it is possible to achieve effective utilization of the facilities of the event venue V.

As described above, according to the present embodiment, a ticket management apparatus acquires a current location of a user terminal held by a user that has purchased a ticket, acquires a required time required to move from the current location to an event venue, and estimates the possibility that the user will cancel participation in the event on the basis of the required time. In addition, it is confirmed with a user having a high possibility of canceling, whether or not there will be a cancellation, and a cancellation process is executed for a user that provides a reply indicating that there will be a cancellation. Due thereto, it is possible to sell a surplus ticket generated due to the cancellation to another user, that user can participate in the event, and it is thereby possible to achieve effective utilization of the facilities of the event venue.

Note that in the embodiment described above, the location of a base station 10 with which a user terminal 20 is connected was used as the current location of the user terminal 20 but, needless to say, it is also possible to use a current position determined by the user terminal 20. In that case, the user terminal 20 may determine its own location by using, for example, GPS, or the like, and may transmit the current location, instead of a cell ID, to the ticket management apparatus 100.

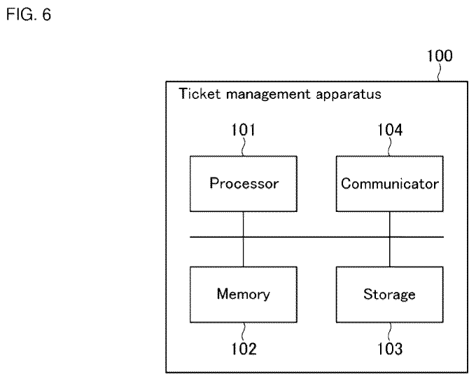

The ticket management apparatus 100 according to embodiment described above may be configured by using a processor and a memory. FIG. 6 is a block diagram illustrating an example of a hardware configuration of the ticket management apparatus 100 according to one embodiment. As illustrated in FIG. 6, the ticket management apparatus 100 includes a processor 101, a memory 102, a storage 103, and a communicator 104.

The processor 101 includes, for example, a Central Processing Unit (CPU), a Field Programmable Gate Array (FPGA), a Digital Signal Processor (DSP), or the like, performs integrated control of the entire the ticket management apparatus 100, and also executes various kinds of information processing.

The memory 102 includes, for example, a Random Access Memory (RAM) or a Read Only Memory (ROM), etc., and stores information to be used in information processing executed by the processor 101.

The storage 103 includes, for example, a Hard Disk Drive (HDD) or a Solid State Drive (SSD), etc., and stores various kinds of data.

The communicator 104 includes an interface for executing wired communication or wireless communication and communicates with the base stations 10 and the map information system 200.

Note that the ticket management apparatus 100 may, for example, have other configurations not shown, such as a display or an operation switch, etc.

The processing by the ticket management apparatus 100 explained in the embodiment above may also be described as a program that can be executed by a computer. In that case, this program can be stored on a computer-readable non-transitory recording medium and installed onto a computer. Examples of such a recording medium include portable recording media such as CD-ROMs, DVD disks, USB memories, etc., and semiconductor memories such as flash memories, etc.

Note that the present disclosure is not limited to the above embodiment and includes various modified examples in which constituent elements have been added, removed, or replaced with respect to the configurations described above.

The present disclosure described above includes the following (1) to (7).
(1) A ticket management apparatus having one or more processors,
   wherein the one or more processors execute a process including:
   acquiring a current location of a wireless communication terminal held by a user that has purchased a ticket to participate in an event;
   acquiring a required time required to move from the current location of the wireless communication terminal to a venue of the event;
   estimating, by comparing the required time and a grace period from the current time until a start time of the event, a possibility that the user will cancel participation in the event; and
   when the estimated cancellation possibility satisfies a prescribed condition, transmitting a message to the wireless communication terminal to confirm whether or not there will be a cancellation.
(2) The ticket management apparatus described in (1) above,
   wherein the acquiring the required time includes
   acquiring a required time calculated from a movement time for moving along a shortest route from the current location of the wireless communication terminal to the venue of the event in accordance with weather and traffic circumstances on the shortest route.
(3) The ticket management apparatus described in (1) or (2) above,
   wherein the estimating includes
   estimating, when the required time exceeds the grace period, that there is a possibility that the user will cancel participation in the event.
(4) The ticket management apparatus described in (3) above,
   wherein the estimating includes
   estimating, when the required time is equal to or less than a time in which a duration of the event is added to the grace period, that there is a possibility that the user will arrive late and participate in the event.
(5) The ticket management apparatus described in (1) or (2) above,
   wherein the acquiring the current location includes:
   acquiring identification information of a cell in which the wireless communication terminal is located; and
   identifying a location of a base station corresponding to the cell for which identification information is acquired.
(6) the ticket management apparatus described in (1) or (2) above,
   wherein the process further includes:
   executing a cancellation process for a ticket associated with the wireless communication terminal when a reply indicating that there will be a cancellation is received from the wireless communication terminal in response to the message; and
   executing a sale process for the ticket for which the cancellation process is executed.
(7) a cancellation estimation method including:
   acquiring a current location of a wireless communication terminal held by a user that has purchased a ticket to participate in an event;
   acquiring a required time required to move from the current location of the wireless communication terminal to a venue of the event;
   estimating, by comparing the required time and a grace period from the current time until a start time of the event, a possibility that the user will cancel participation in the event; and
   when the estimated cancellation possibility satisfies a prescribed condition, transmitting a message to the wireless communication terminal to confirm whether or not there will be a cancellation.

### REFERENCE SIGNS LIST

10 Base station
20 User terminal
100 Ticket management apparatus
101 Processor
102 Memory
103 Storage
104 Communicator
110 Communication I/F
120 Ticket information storage device
130 Cell ID collector
140 Required time acquirer
150 Cancellation estimator
160 Cancellation confirmer
170 Cancellation processing device
180 Sale processing device
200 Map information system

1. A ticket management apparatus having one or more processors,
wherein the one or processors execute a process comprising:
acquiring a current location of a wireless communication terminal held by a user that has purchased a ticket to participate in an event;
acquiring a required time required to move from the current location of the wireless communication terminal to a venue of the event;
estimating, by comparing the required time and a grace period from a current time until a start time of the event, a possibility that the user will cancel participation in the event; and
when the estimated cancellation possibility satisfies a prescribed condition, transmitting a message to the wireless communication terminal to confirm whether or not there will be a cancellation.

2. The ticket management apparatus according to claim 1, wherein
the acquiring the required time comprises
acquiring a required time calculated from a movement time for moving along a shortest route from the current location of the wireless communication terminal to the venue of the event in accordance with weather and traffic circumstances on the shortest route.

3. The ticket management apparatus according to claim 1, wherein
the estimating comprises
estimating, when the required time exceeds the grace period, that there is a possibility that the user will cancel participation in the event.

4. The ticket management apparatus according to claim 3, wherein
the estimating comprises
estimating, when the required time is equal to or less than a time in which a duration of the event is added to the grace period, that there is a possibility that the user will arrive late and participate in the event.

5. The ticket management apparatus according to claim 1, wherein
the acquiring the current location comprises:
acquiring identification information of a cell in which the wireless communication terminal is located; and
identifying a location of a base station corresponding to the cell for which identification information is acquired.

6. The ticket management apparatus according to claim 1,
wherein the process further comprises:
executing a cancellation process for a ticket associated with the wireless communication terminal when a reply indicating that there will be a cancellation is received from the wireless communication terminal in response to the message; and
executing a sale process for the ticket for which the cancellation process is executed.

7. A cancellation estimation method comprising:
acquiring, using a processor, a current location of a wireless communication terminal held by a user that has purchased a ticket to participate in an event;
acquiring, using the processor, a required time required to move from the current location of the wireless communication terminal to a venue of the event;
estimating, by comparing the required time and a grace period from a current time until a start time of the event using the processor, a possibility that the user will cancel participation in the event; and
when the estimated cancellation possibility satisfies a prescribed condition, transmitting a message to the wireless communication terminal to confirm whether or not there will be a cancellation.
